(19) United States
(12) Patent Application Publication
(10) Pub. No.: US 2011/0134120 A1
(43) Pub. Date: Jun. 9, 2011

(54) METHOD AND COMPUTING DEVICE FOR CAPTURING SCREEN IMAGES AND FOR IDENTIFYING SCREEN IMAGE CHANGES USING A GPU

(75) Inventors: VIKTOR ANTONYUK, Calgary (CA); Erik Benner, Calgary (CA); Shymmon Banerjee, Calgary (CA)

(73) Assignee: SMART Technologies ULC, Calgary (CA)

(21) Appl. No.: 12/632,178

(22) Filed: Dec. 7, 2009

(51) Int. Cl. G06T 15/50; G09G 5/02

(52) U.S. Cl. 345/426; 345/589; 345/667; 345/506

(57) ABSTRACT

A method for identifying changes between a current image and a previous image comprises generating a mask using a graphics processing unit, the mask identifying differences between the current and previous images using the graphics processing unit to identify at least a portion of the current image based on the mask and copying image data of the current image corresponding to the identified portions from memory associated with the graphics processing unit to memory associated with a central processing unit.

### FIELD OF THE INVENTION

The present invention relates generally to computer screen image capturing, and in particular to a method and computing device for capturing screen images and for identifying screen image changes using a graphics processing unit (GPU).

### BACKGROUND OF THE INVENTION

Computer screen image capturing has been widely used in computerized collaboration, remote access, and screen sharing applications. In these applications, images of a computer desktop or a graphical user interface (GUI) of a designated application program that is displayed on the display monitor of a host computer are captured and the captured images are transmitted to a plurality of remote computers for display. Screen image capturing is also used in screen mirroring applications, where on a computer having multiple monitors, the screen images or the GUI of a designated application program shown on one of the monitors are captured and then copied to one or more of the other monitors. For example, Bridgit™ conferencing software offered by SMART Technologies ULC of Calgary, Alberta, Canada, assignee of the subject application, allows a plurality of computers connected to a Bridgit™ server to share the same screen image. In particular, the computer of the Bridgit™ conference that is designated as the host computer, captures screen images of its desktop and then transmits the captured screen images to other computers via the Bridgit™ server for display.

With the increase of screen image resolution and the increase in rates by which screen images can be transmitted or streamed to remote computers, transmitting full screen images from a host computer to remote computers requires significant communications bandwidth. Various methods have been considered to address this problem. For example, U.S. Patent Application Publication No. 2008/0065996 to Noel et al. published on Mar. 13, 2008 and assigned to SMART Technologies ULC, the content of which is incorporated herein by reference, discloses a desktop sharing system and method. The desktop sharing system runs a desktop sharing application that permits screen images of a host computer's desktop to be shared with other remote computers during a conference. During desktop sharing, screen images of the desktop to be shared are captured and divided into a series of key frames interleaved with intermediate frames, where every key frame is followed by one or more intermediate frames. The full screen image corresponding to each key frame is transmitted from the host computer to each of the remote computers participating in the conference. For each intermediate frame, an intermediate delta frame representing the difference between the intermediate frame and its previous frame is transmitted from the host computer to each of the remote computers participating in the conference. At each receiving remote computer, shared screen images are reconstructed using the key frames and the intermediate delta frames and displayed.

Processing captured screen images to yield the key frames and the intermediate delta frames in real-time is computationally expensive especially when the captured screen images are of a high resolution. This problem is compounded as screen resolutions increase due in large part to improvements in display technology. As a result, a significant processing burden can be placed on the central processing unit (CPU) of the host computer. General-purpose graphics processing units (GPGPUs) are becoming more popular for use in computer systems to relieve CPUs from the burden of graphics related processing as GPGPUs provide hardware acceleration for graphics processing. Moreover, because of their highly parallel structure, GPGPUs have proven to be more efficient in 2D/3D graphics rendering and processing. The programmable capability of GPGPUs also provides programmers with great flexibility to design high-efficiency graphics applications.

It is therefore an object of the present invention at least to provide a novel computing device and method for capturing screen images and for identifying screen image changes using a GPU.

### SUMMARY OF THE INVENTION

Accordingly, in one aspect there is provided a method for identifying changes between a current image and a previous image, said method comprising generating a mask using a graphics processing unit, said mask identifying differences between said current and previous images; using the graphics processing unit to identify portions of the current image based on the mask; and copying image data of the current image corresponding to the identified portions from memory associated with the graphics processing unit to memory associated with a central processing unit.

In one embodiment, each portion identified by the graphics processing unit comprises a plurality of pixels of the current image. Each pixel of the mask corresponds to a tile of the current image and each portion identified by the graphics processing unit corresponds to a tile of the current image. During the mask generating, pixels of the mask associated with tiles of the current image that differ from corresponding tiles of the previous image are assigned a first value. The graphics processing unit uses pixels having the first value to identify the portions of the current image that are different from corresponding portions of the previous image.

In one embodiment, the mask generating further comprises generating a difference image by comparing the current and previous images; and subjecting the difference image to an iterative size reduction procedure to yield a miniature mask. The miniature mask comprises pixel values identifying tiles of the current image that differ from corresponding tiles of the previous image. The image data copied to memory associated with the central processing unit is transmitted to at least one remote computing device.

According to another aspect there is provided a method for identifying changes between first and second images comprising generating a difference image by comparing said first and second images; generating a mask based on said difference image, said mask having row and column dimensions smaller than said difference image; and identifying tiles of the first image that differ from corresponding tiles of said second image using said mask.

In one embodiment, the first and second images are current and previous computer screen images. The difference image generating, mask generating and tile identifying are performed by a graphics processing unit and the identified tiles are copied from the graphics processing unit to a central processing unit.

According to yet another aspect there is provided a method for identifying changes between a first image and a second image, said method comprising generating a first miniature image frame by iteratively reducing the dimensions of said first image; generating a second miniature image frame by iteratively reducing the dimensions of said second image; generating a difference image by comparing said first and second miniature image frames; and identifying portions of the first image that differ from corresponding portions of the second image using said difference image.

According to yet another aspect there is provided a computing device comprising at least one first processing unit; first storage associated with said at least one first processing unit; at least one second processing unit; and second storage associated with said at least one second processing unit, said second storage storing first and second data sets, wherein said second processing unit is configured to identify changes between the first data set and the second data set and to convey the identified changes to said first processing unit for storage in said first storage.

In one embodiment, the first processing unit is a central processing unit and the second processing unit is a graphics processing unit. The central processing unit is configured to transmit the identified changes to at least one remote computing device. The first and second data sets comprise current and previous screen images. The second storage is graphics memory and the current and previous screen images are stored in different buffers of the graphics memory. The graphics processing unit may comprise shader pipelines or a hardware bit-wise XOR operation.

According to yet another aspect there is provided a computer readable medium embodying executable code which when executed by a computing device causes the computing device to perform a method for identifying changes between a first image and a second image, the method comprising generating a first miniature image frame by iteratively reducing the dimensions of said first image; generating a second miniature image frame by iteratively reducing the dimensions of said second image; generating a difference image by comparing said first and second miniature image frames; and identifying portions of the first image that differ from corresponding portions of the second image using said difference image.

According to still yet another aspect there is provided a computer readable medium embodying executable code which when executed by a computing device causes the computing device to perform a method for identifying changes between a first image and a second image, the method comprising generating a difference image by comparing said first and second images; generating a mask based on said difference image, said mask having row and column dimensions smaller than said difference image; and identifying tiles of the first image that differ from corresponding tiles of said second image using said mask.

### BRIEF DESCRIPTION OF THE DRAWINGS

Embodiments will now be described more fully with reference to the accompanying drawings in which:

FIG. 1 is a simplified diagram of a computing device comprising a general-purpose graphics processing unit (GPGPU);

FIG. 2 is a block diagram of the GPGPU architecture;

FIG. 3 illustrates the software structure resident on the computing device of FIG. 1 related to graphics processing;

FIG. 4 illustrates an exemplary graphics memory map during screen image capturing;

FIG. 5A is a flowchart showing the steps performed by the computing device of FIG. 1 during execution of a screen sharing application;

FIG. 5B illustrates the steps performed by the GPGPU during an iterative miniature mask generation procedure;

FIGS. 6A and 6B are exemplary screen images stored in current and previous frame buffers, respectively;

FIG. 6C is a difference image generated from the screen images of FIGS. 6A and 6B;

FIG. 6D is a miniature mask generated from the difference image of FIG. 6C;

FIG. 6E shows the dimensions of miniature masks compared to a full-size screen image after a plurality of iterations of the miniature mask generation procedure of FIG. 5B;

FIG. 6F shows changed pixel tiles of the screen image of FIG. 6A compared to the screen image of FIG. 6B;

FIG. 7 illustrates another exemplary graphics memory map during screen image capturing;

FIG. 8 is a flowchart showing the steps performed by the computing device of FIG. 1 during execution of an alternative screen sharing application; and

FIG. 9 shows an exemplary difference image generated by the screen sharing application of FIG. 8.

### DETAILED DESCRIPTION OF THE EMBODIMENTS

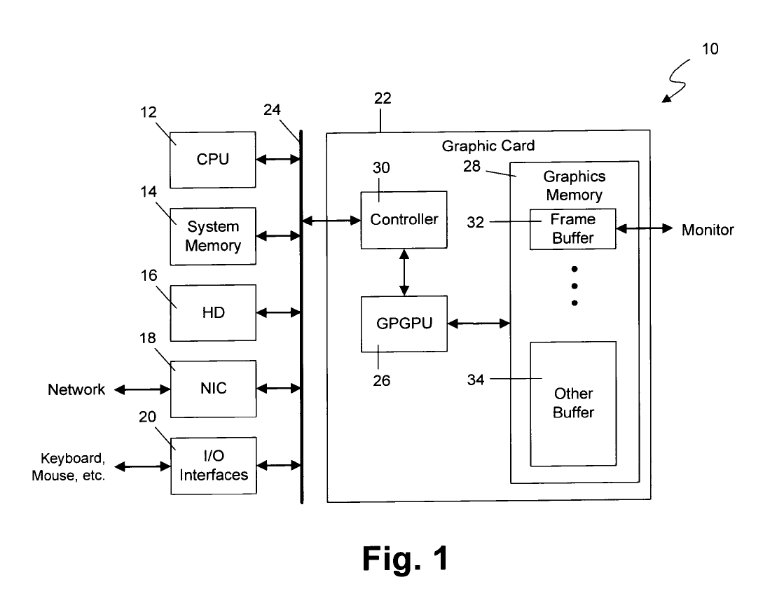

Turning now to FIG. 1, a computing device is shown and is generally identified by reference numeral 10. The computing device 10 comprises at least one central processing unit (CPU) 12, system memory 14, one or more long-term storage devices such as hard drives (HDs) 16, a wired or wireless network interface card (NIC) that connects the computing device 10 to a network, input/output (I/O) interfaces 20 that permit peripheral devices, such as for example a keyboard, a touch screen or other interactive input surface, and/or a mouse, to be connected to the computing device 10, and at least one graphic component 22 that connects to one or more display monitors. The graphic component 22 is connected to the CPU 12, system memory 14, hard drives 16, NIC 18 and I/O interfaces 20 via a system bus 24.

The graphic component 22 may be in the form of a graphic card installed in an extension slot of the computing device motherboard. Alternatively, the graphic component 22 may be integrated in the computing device motherboard or integrated within the CPU 12. The graphic component 22 in this embodiment comprises a general-purpose graphics processing unit (GPGPU) 26, which communicates with graphics memory 28, and with a controller 30. The controller 30 is an industry standardized interface (e.g., AGP, PCI-E, PCI, etc) that couples the graphic component 22 to the system bus 24. The graphics memory 28 is partitioned into a plurality of different buffers and comprises at least one frame buffer 32. Each frame buffer 32 is coupled to an associated display monitor and serves screen image data to its associated display monitor for display thereon.

When the graphics memory 28 comprises two or more frame buffers 32, the computing device 10 is provided with multi-monitor capabilities as each frame buffer 32 is able to serve an individual display monitor with screen image data. Alternatively, two or more graphic components 22 may be installed in the computing device motherboard to give the computing device 10 multi-monitor capabilities. In this case, each graphic component 22 may comprise graphics memory 28 that includes a single frame buffer 32 or graphics memory 28 that includes a plurality of frame buffers 32.

The GPGPU 26 provides hardware acceleration for graphics processing. The GPGPU 26 also provides advanced features, such as for example, hardware exclusive-OR (XOR) operations and/or shaders to further improve the performance of graphics processing. As is known, shaders are parallel processing structures with similar architecture that process data at the same time.

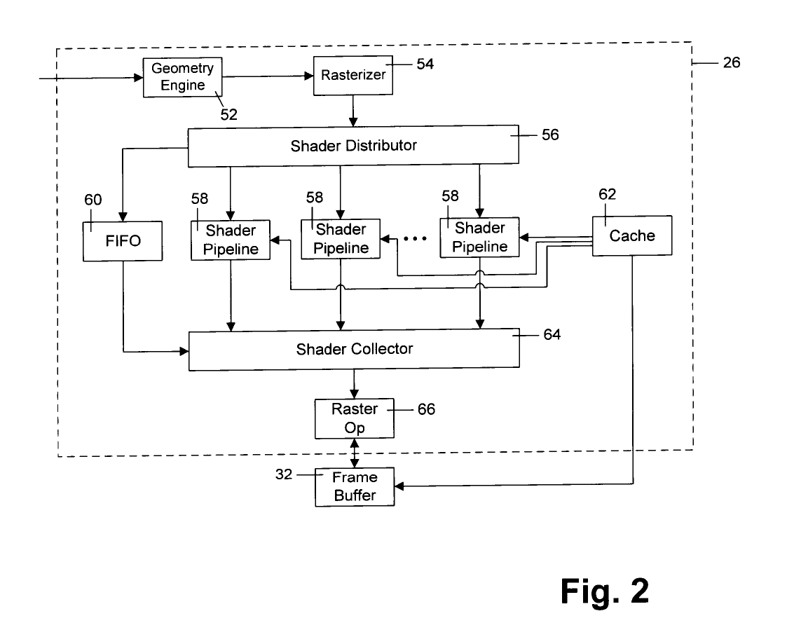

FIG. 2 is a block diagram showing the architecture of the GPGPU 26. In this embodiment, the GPGPU 26 is similar to that disclosed in U.S. Pat. No. 7,385,607 to Bastos et al. issued on Jun. 10, 2008 and entitled “Scalable Shader Architecture”, assigned to NVIDIA Corp., the content of which is incorporated herein by reference. As can be seen, the GPGPU 26 comprises a geometry engine 52 connected to a rasterizer 54. Rasterizer 54 in turn is connected to a shader distributor 56. Shader distributor 56 is connected in parallel to shader pipelines 58 and to a first-in-first-out (FIFO) buffer 60. The shader pipelines 58 and FIFO buffer 60 are connected to a shader collector 64. A raster operations processor 66 communicates with the shader collector 64 as well as with the frame buffer(s) 32 of the graphics memory 28. High-speed cache memory 62 communicates with each shader pipeline 58 as well as with the frame buffer(s) 32 of the graphics memory 28.

During operation of the GPGPU 26, image data from CPU 12 and/or system memory 14 is fed to the geometry engine 52 via the system bus 24 for processing. The processed image data output by the geometry engine 52 is sent to the rasterizer 54. The rasterizer 54 in turn generates rasterized pixel data, which is output to the shader distributor 56. The shader distributor 56 parses the rasterized pixel data and sends the pixel data to the shader pipelines 58 and FIFO buffer 60. The shader pipelines 58 process the pixel data in parallel with the assistance of the high-speed cache memory 62. As pixel data is processed by the shader pipelines 58 of the GPGPU 26 in parallel, processing performance is significantly improved as compared to processing the image data using the CPU 12, which processes pixel data sequentially. The processed pixel data output by the shader pipelines 58 and FIFO buffer 60 is collected by the shader collector 64, and sent to the raster operations processor 66 for additional processing. The resulting pixel data is then sent by the raster operations processor 66 to the graphics memory 28 for storage in the appropriate frame buffer 32. Once stored in the frame buffer 32, the frame buffer 32 serves the pixel data to its associated display monitor for display.

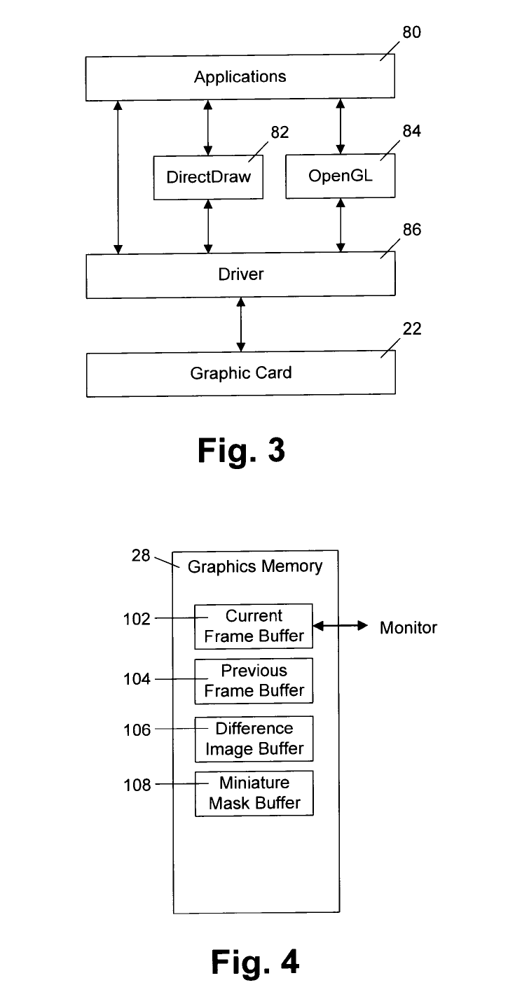

FIG. 3 illustrates the software structure resident on the computing device 10 related to graphics processing. As can be seen, the software structure comprises a driver 86 that provides an interface for accessing the graphic component 22. Software applications 80 may call driver functions directly, or may call driver functions via DirectDraw® 82 or OpenGL® 84, in order to copy image data from a frame buffer 32 of graphics memory 28, output image data to a frame buffer 32, and/or request the GPGPU 26 in the graphic component 22 to process image data.

To avoid the bottlenecks associated with copying significant amounts of image data to the system memory 14 and with processing the image data using the CPU 12, and to take advantage of the processing speed of the GPGPU 26, the computing device 10 runs a screen sharing application that exploits both the GPGPU 26 and CPU 12. The screen sharing application runs at the applications level 80. The screen sharing application accesses the graphic component 22 via the driver 86 alone, via DirectDraw 82 and the driver 86, or via OpenGL 84 and the driver 86.

During execution, the screen sharing application partitions captured screen images into a series of key frames interleaved with intermediate frames, where a key frame is usually followed by one or more intermediate frames. In some instances, such as for example when screen images change abruptly, two or more key frames may be generated consecutively without interleaved intermediate frames. Each key frame represents a full screen image and is copied by the screen sharing application from a frame buffer 32 of the graphic component 22 to the system memory 14.

When the screen sharing application is used for computerized conferencing, the screen sharing application transmits each key frame to each remote computing device participating in the conference over a suitable network connection. For every intermediate frame, the screen sharing application finds the changes between the current screen image and the previous screen image based on a miniature of a difference image constructed from the current and previous screen images. The screen sharing application then only copies the changed portion of the current screen image from the frame buffer 32 of the graphic component 22 to the system memory 14, and transmits the changed portion of the current screen image to over the network connection to each remote computing device participating in the conference as an intermediate delta frame. At each receiving remote computing device, screen images to be shared are reconstructed using the key frames and the intermediate delta frames and displayed. When the screen sharing application is used during screen mirroring, the screen sharing application transmits the key frames and intermediate delta frames either to one or more other graphic components 22 of the computing device 10 or to one or more frame buffers 32 of the same graphic component 22 thereby to enable the screen image to be displayed on one or more other display monitors of the computing device 10.

FIG. 4 illustrates an exemplary graphics memory map during screen capturing. For ease of description, the frame buffer 32 in the graphics memory 28 shown in FIG. 1 is referred to and shown as the current frame buffer 102 in FIG. 4. The screen sharing application creates a plurality of buffers in the graphics memory 28, namely a previous frame buffer 104 which stores a previous screen image that is at least one frame before the current screen image, a difference image buffer 106 and a miniature mask buffer 108.

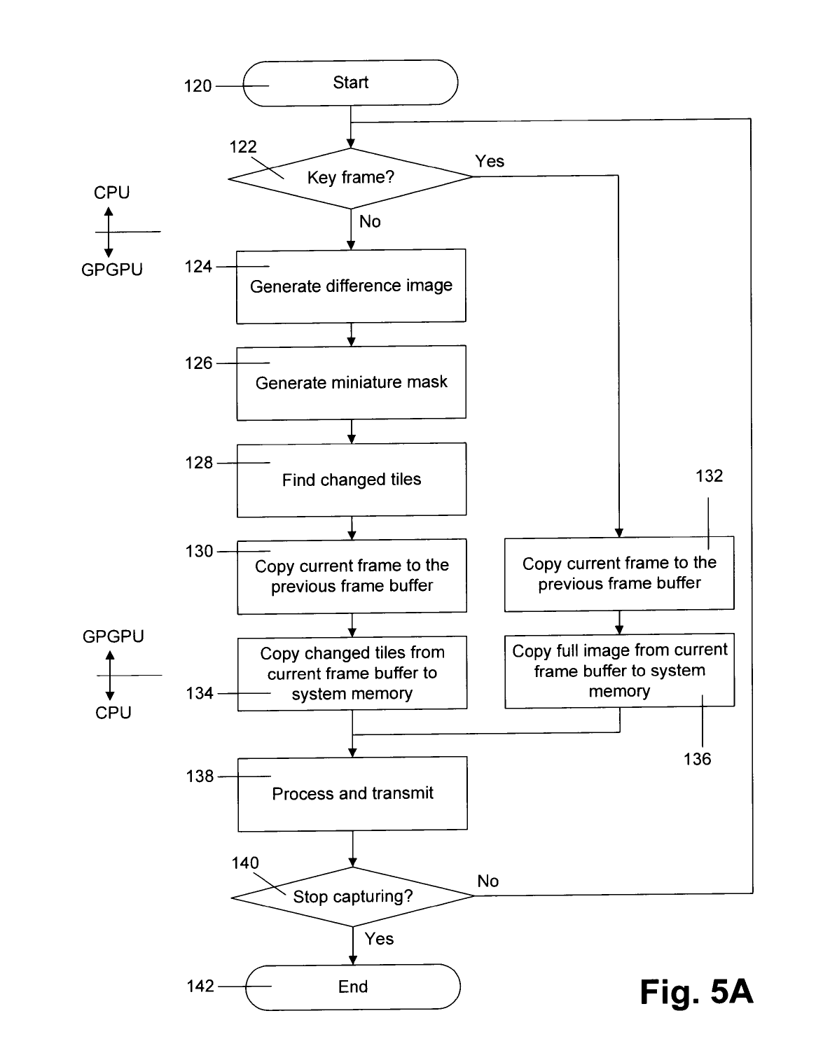

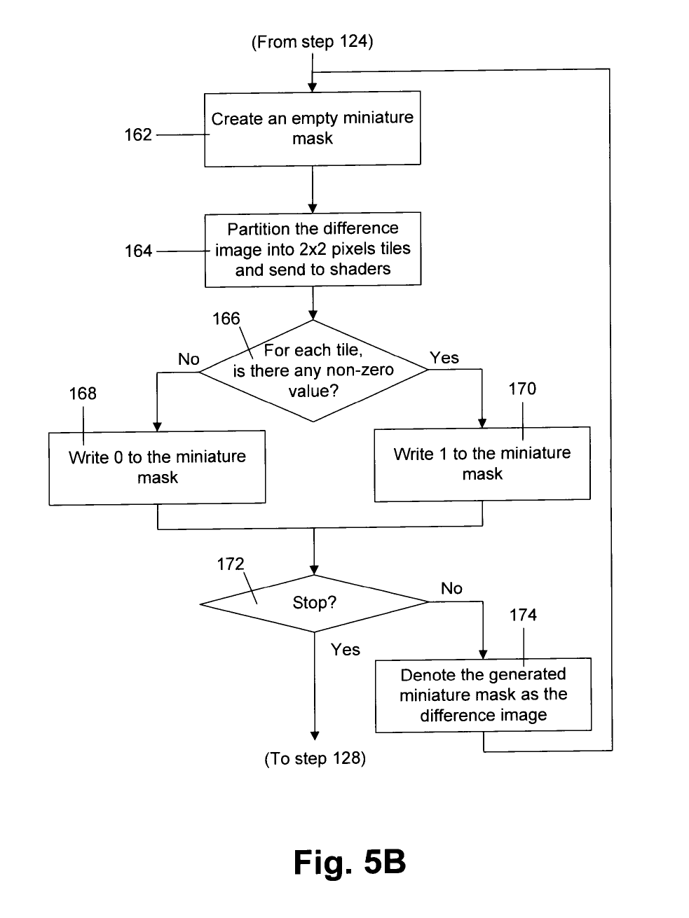

FIG. 5A is a flowchart showing the steps performed by the computing device 10 during execution of the screen sharing application when used for computerized conferencing. Once execution of the screen sharing application has started (step 120), the screen sharing application causes the CPU 12 to check the screen image stored in the current frame buffer 102 to determine whether the screen image is a key frame (step 122). Various criteria can be used by the CPU 12 to determine whether the screen image is a key frame or not. For example, key frames may be defined as the (kN)th screen images, where N is a predefined integer, and k=0, 1, 2, . . . ; and/or be defined as the screen images displayed at (kt) second, where t is a predefined time period, and k=0, 1, 2, . . . . A screen image may also be categorized as a key frame if it is significantly different from the screen image stored in the previous frame buffer 104.

At step 122, if the screen image in the current frame buffer 102 is determined by the CPU 12 to be a key frame, the GPGPU 26 is instructed by the CPU 12 to copy the complete screen image in the current frame buffer 102 to the previous frame buffer 104 (step 132). The GPGPU 26 is also instructed by the CPU 12 to copy the complete screen image to the system memory 14 using asynchronous direct memory access (DMA) (step 136) or other suitable memory copy method.

After the complete screen image has been copied to the system memory 14, the complete screen image which represents the key frame is processed by the CPU 12 and then transmitted over the network connection to each of the remote computing devices participating in the conference (step 138). The processing performed by the CPU 12 may be the result of user or computing device requirements, and/or may include image compression, e.g., Run-length encoding (RLE), Fast Fourier Transform (FFT), Discrete Cosine Transform (DCT), Wavelet Transform, etc.

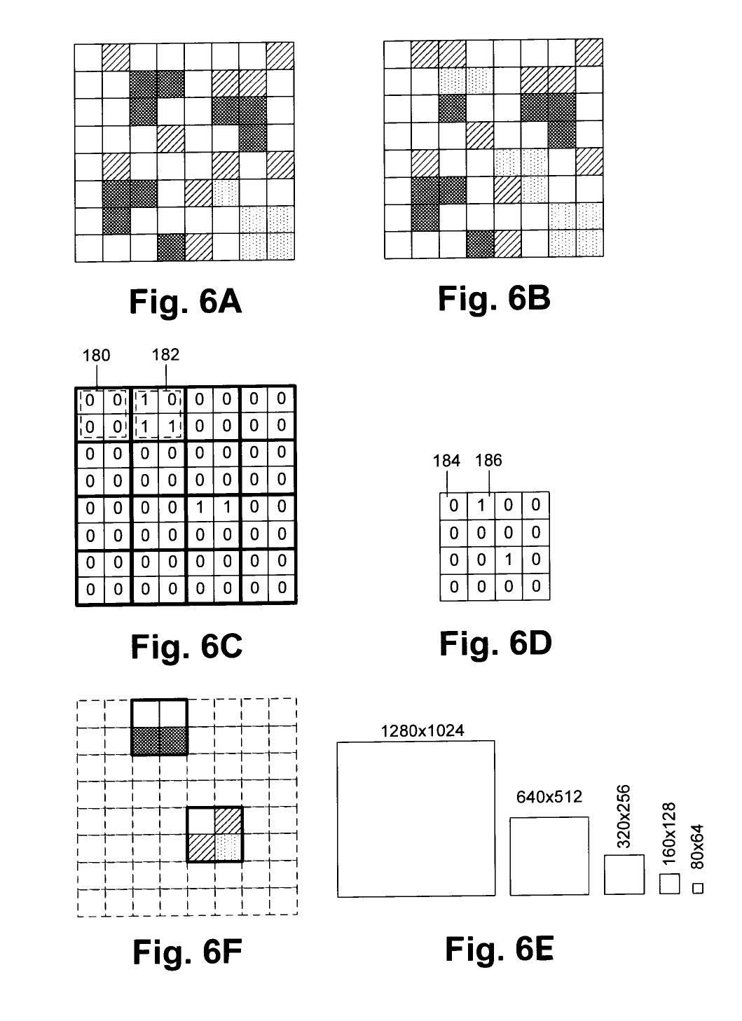

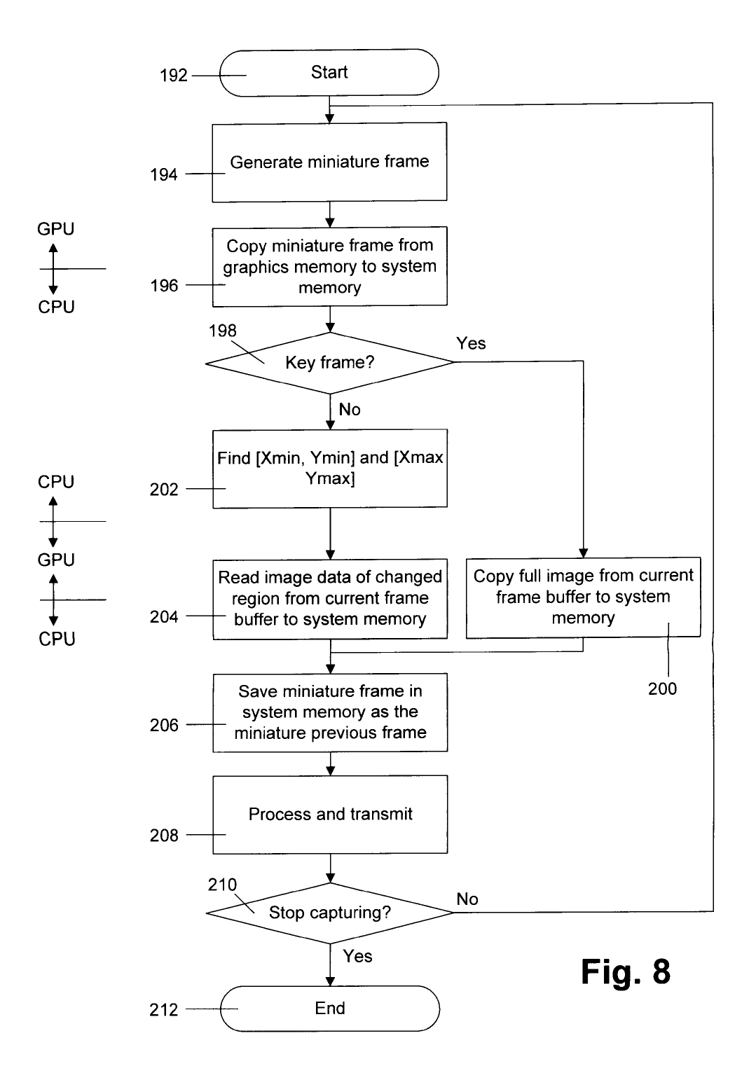

At step 122, if it is determined by the CPU 12 that the screen image stored in the current frame buffer 102 is not a key frame, the CPU 12 instructs the GPGPU 26 to generate a difference image or mask using the screen images stored in the current frame buffer 102 and the previous frame buffer 104 (step 124). FIG. 6A shows an exemplary screen image stored in the current frame buffer 102 and FIG. 6B shows an exemplary screen image stored in the previous frame buffer 104. During generation of the difference image, the GPGPU 26 parses the pixels of the screen images stored in the current frame buffer 102 and the previous frame buffer 104 into the shader pipelines 58 so that the pixels of the screen images are processed in parallel. The value of each pixel of the difference image is determined by comparing the corresponding pixels of the two screen images. If a pixel of the screen image stored in the current frame buffer 102 is the same as the corresponding pixel of the screen image stored in the previous frame buffer 104, the corresponding pixel of the difference image is set to zero (0); otherwise, the corresponding pixel of the difference image is set to one (1). A black/white difference image is therefore generated and stored in the difference image buffer 106, where each pixel of the difference image is represented by one (1) bit, black pixels of the difference image (i.e., pixels with a zero (0) bit value) represent no change between the screen images in the current and previous frame buffers 102 and 104 respectively, and white pixels of the difference image (i.e., pixels with a one (1) bit value) represent changes between screen images in the current and previous frame buffers 102 and 104 respectively. FIG. 6C shows the difference image generated from the screen images shown in FIGS. 6A and 6B.

After generating the difference image, the GPGPU 26 then generates a miniature mask (step 126) from the difference image using an iterative procedure and stores the miniature mask in the miniature mask buffer 108. FIG. 5B illustrates the steps performed by the GPGPU 26 during miniature mask generation. At the start of the iterative miniature mask procedure, the GPGPU 26 initially creates an empty miniature mask (step 162). The miniature mask has row and column dimensions that are one half the size of the difference image row and column dimensions. Thus, each pixel of the miniature mask corresponds to a 2×2 pixel area of the difference image.

At step 164, the GPGPU 26 partitions the difference image into 2×2 pixel tiles and processes the pixel tiles of the difference image using the shader pipelines 58 to determine whether any of the pixel tiles comprise one or more pixels having a non-zero value (step 166). For each pixel tile, if the values of the four pixels d₁, d₂, d₃, d₄ therein are all equal to zero (0), the GPGPU 26 writes a zero (0) value to the corresponding pixel of the miniature mask (step 168); otherwise, the GPGPU 26 writes a one (1) value to the corresponding pixel of the miniature mask (step 170).

Various methods may be used by the shader pipelines 58 at step 166 to examine the pixels of the pixel tiles to determine if one or more pixels of any of the pixel tiles have non-zero values. In this embodiment, a computationally fast binary OR operation is used by the shader pipelines 58 to determine if one or more pixels of any of the pixel tiles have non-zero values. That is, for each 2×2 pixel tile, each shader pipeline 58 solves Equation (1) below:

m₁=d₁ OR d₂ OR d₃ OR d₄ (Eq. 1)

The value of m₁ is then written to the corresponding pixel of the miniature mask. Because the pixels d₁, d₂, d₃ and d₄ of each pixel tile are binary, m₁ has a zero (0) value only if the values of pixels dᵢ, d₂, d₃ and d₄ are all equal to zero (0); otherwise m₁ has a one (1) value. FIG. 6D shows the miniature mask generated from the difference image of FIG. 6C, after one iteration of the miniature mask generation procedure.

Using the difference image of FIG. 6C as an example, the value of m₁ is calculated using the pixels in the pixel tile 180 to obtain the value of the corresponding pixel 184 of the miniature mask shown in FIG. 6D. Since the four pixels in the pixel tile 180 all have values equal to zero (0), the value of the corresponding pixel 184 is also equal to zero (0), which implies that the pixel tile 180 in FIG. 6C corresponding to the pixel 184 of the miniature mask in FIG. 6D represents an unchanged pixel tile in the screen image stored in the current frame buffer 102. Similarly, the value of m₁ is calculated using the pixels in the pixel tile 182 to obtain the value of the corresponding pixel 186 of the miniature mask shown in FIG. 6D. Since two pixels in the pixel tile 182 have values equal to one (1), the value of the corresponding pixel 186 is equal to one (1), which implies that the pixel tile 182 in FIG. 6C corresponding to the pixel 186 of the miniature mask in FIG. 6D represents a changed pixel tile in the screen image stored in the current frame buffer 102.

At step 172, a check is made to determine if an iteration stop threshold has been reached. If the iteration stop threshold has been reached, the miniature mask generation procedure is deemed complete. If the iteration stop threshold has not been reached, the generated miniature mask is denoted as the difference image (step 174), and the miniature mask generation procedure returns to step 162.

In this embodiment, a defined number of iterations is used as the iteration stop criterion at step 172. The defined number of iterations may be user defined or predefined. As will be appreciated, the number of iterations determines the final size of the resultant miniature mask at the completion of the miniature mask generation procedure. FIG. 6E shows the dimensions of miniature masks after a series of iterations of the miniature mask generation procedure. In this example, an initial 1280×1024 pixel difference image is reduced to an 80×64 pixel miniature mask after four (4) iterations. Of course, other iteration stop criteria may also be used, e.g., whether the miniature mask is smaller than a predefined size. Each pixel of the resultant miniature mask corresponds to a rectangular pixel tile of the original difference image. In the example of FIG. 6E, each pixel of the resultant 80×64 pixel miniature mask corresponds to a 16×16 pixel tile of the 1280×1024 pixel difference image.

Returning to FIG. 5A, after the resultant miniature mask has been generated at step 126, the GPGPU 26 uses the miniature mask to find changed pixel tiles in the screen image stored in the current frame buffer 102 (step 128). In particular, the GPGPU 26 examines the pixels of the resultant miniature mask to locate pixels therein having a one (1) value. The pixel tiles of the screen image stored in the current frame buffer 102 corresponding to the pixels of the resultant miniature mask that have one (1) values represent changed pixel tiles. FIG. 6F shows changed pixel tiles of the screen image of FIG. 6A that are identified using the miniature mask of FIG. 6D. The GPGPU 26 then copies the screen image stored in the current frame buffer 102 to the previous frame buffer 104 (step 130). Following this, the GPGPU 26 copies each changed pixel tile of the screen image stored in the current frame buffer 102 determined at step 128 from the graphics memory 28 to the system memory 14 (step 134) using asynchronous DMA or other suitable memory copy method. Because there are typically only small changes between two consecutive screen images, the number of changed pixel tiles that are copied to the system memory 14 is usually small. Thus, for intermediate frames, only a small amount of image data is transferred from the graphics memory 28 to the system memory 14. By reducing the amount of image data that is transferred between the graphics memory 28 and the system memory 14, the bottleneck associated with this image data transfer process is avoided resulting in an increase in performance.

After each changed pixel tile has been copied to the system memory 14, the changed pixel tile(s) which represent(s) the intermediate delta frame is (are) processed by the CPU 12 and the intermediate delta frame is transmitted over the network connection to each of the remote computing devices participating in the conference (step 138). Again, the processing performed by the CPU 12 may be the result of user or computing device requirements, and/or may include image compression, e.g., Run-length encoding (RLE), Fast Fourier Transform (FFT), Discrete Cosine Transform (DCT), Wavelet Transform, etc.

The above procedure loops through steps 122 to 138 for as long as screen sharing in the conference session continues. As a result, screen images of the host computing device are continually shared with the remote computing devices participating in the conference until screen sharing is stopped. When screen sharing is stopped or when the conference session is terminated, the screen sharing application terminates the loop (step 140).

In the above description, when comparing the one (1) bit pixel values, a result of zero (0) represents no difference between the pixels being compared, and a result of one (1) represents the two pixels being different. Those skilled in the art will appreciate that this convention is arbitrary and that other digital logic conventions may be used. For example, when comparing two pixels, a result of one (1) may represent no difference between the pixels being compared, and a result of zero (0) may represent the two pixels being different.

In the above embodiment, the screen sharing application is described as being executed by a computing device 10 that comprises a GPGPU 26 having shader pipelines 58. However, the screen sharing application may also be executed by a computing device 10 comprising a GPGPU that does not include shader pipelines. For example, if the screen sharing application is executed on a computing device 10 that comprises a GPGPU 26 that implements a hardware bit-wise XOR operation but does not include shader pipelines, a procedure similar to that shown in FIG. 5A is performed with the exception that steps 124 and 126 are modified as will now be described. In this embodiment, at step 124, the screen sharing application uses a hardware bit-wise XOR operation to compare the screen image stored in the current frame buffer 102 with the screen image stored in the previous frame buffer 104 in order to generate the difference image. As most GPGPUs, irrespective of whether they include shader pipelines 58, implement hardware bit-wise XOR operations, the difference image can be generated by the GPGPU 26 very quickly.

Unlike the difference image generated in the previous embodiment, the difference image generated using the hardware bit-wise XOR operation is not a black/white image. Moreover, each pixel of the difference image generated using the hardware bit-wise XOR operation has the same length as each pixel of the screen image. If a pixel of the screen image stored in the current frame buffer 102 is the same as the corresponding pixel of the screen image stored in the previous frame buffer 104, the corresponding pixel of the difference image will be black and will have a zero (0) value. However, if a pixel of the screen image stored in the current frame buffer 102 is not the same as the corresponding pixel of the screen image stored in the previous frame buffer 104, the corresponding pixel of the difference image will have a non-zero value representing a color which is not necessarily white.

As will be appreciated, pixels of the difference image that have non-zero values may represent minor or insignificant differences between the screen image stored in the current frame buffer 102 and the screen image stored in the previous frame buffer 104. In this case, it may be desired to process the pixels of the difference image to remove those pixels that represent minor or insignificant changes between the screen image stored in the current frame buffer 102 and the screen image stored in the previous frame buffer 104. This can be achieved either by comparing the pixels of the difference image to a threshold or by applying the difference image to a mask. Below is an example of using a mask to remove pixels of the difference image that represent minor or insignificant changes between the screen image stored in the current frame buffer 102 and the screen image stored in the previous frame buffer 104. For ease of description, each pixel of the difference image is assumed to be represented by an eight (8) bit grayscale binary value.

Let P1 and P2 represent corresponding pixels of the screen image stored in the current frame buffer 102 and the screen image stored in the previous frame buffer 104, respectively. The difference D of pixels P1 and P2 is then:

D=P1 XOR P2,

where the XOR operation is a hardware bit-wise operation. For example, if pixel P1=1110 1101 and pixel P2=1101 1100, then difference D=0011 0001.

Here, the left-most bit is the Most Significant Bit (MSB) and the right-most bit is the Least Significant Bit (LSB). The threshold used to signify a minor or insignificant change depends on the system design requirements. In this example, it is assumed that any difference D having a value less than six (6), (i.e., D<0000 0010), represents a minor or insignificant change between the screen image stored in the current frame buffer 102 and the screen image stored in the previous frame buffer 104. To omit pixels from the difference image having values representing such minor or insignificant changes, a mask is defined. The mask M and the difference D are then subjected to a bit-wise AND operation. In this embodiment, the mask M is selected so that the result R of the bit-wise AND operation will have bit values equal those of the difference D at bit locations corresponding to the one (1) value bits in the mask M and will have bit values equal to zero (0) at bit locations corresponding to the zero (0) value bits in the mask M.

For example, in the case of the difference D=0000 0010 generated from the pixels P1 and P2 and the mask M=1111 1100, the result R=0011 0000 signifies a non-minor difference between the screen image stored in the current frame buffer 102 and the screen image stored in the previous frame buffer 104. In this case, the difference D generated from the pixels P1 and P2 is maintained in the difference image.

If pixel P1=1011 1111 and pixel P2=1011 1101 (i.e., they are slightly different), and mask M=1111 1100, then the difference D=P1 XOR P2=0000 0010, and the result R=D AND M=0000 0000 signifies a minor or insignificant change between the screen image stored in the current frame buffer 102 and the screen image stored in the previous frame buffer 104. As a result, the difference D generated from the pixels P1 and P2 is removed from the difference image.

At step 126 after the difference image has been generated and processed to remove pixels representing minor or insignificant changes, if desired, the screen sharing application iteratively generates the miniature mask from the difference image using an image-resizing algorithm, such as for example, Nearest Neighbor, Bilinear, Bicubic, Lanczos, etc., or using an available API function, such as for example, the Bitblt function in the Microsoft° Windows® platform. Following each iteration, the row and column dimensions of the miniature mask are halved. Of course, an image-resizing technique that reduces the size of the miniature mask by a different reduction factor, e.g. a factor of 4, after each iteration may also be used. Depending on the environment and system requirements, the resultant miniature mask may be directly generated from the difference image following a single iteration. Unlike the previous embodiment which captures all changes in the screen image stored in the current frame buffer 102, this methodology of forming the difference and miniature images may not capture subtle changes between the screen images stored in the current and previous frame buffers 102 and 104, respectively, depending on averaging effects introduced by the image-resizing algorithm that is selected.

The above difference and miniature image forming procedure has been found to be suitable when implemented by GPGPUs 26 that implement hardware bit-wise XOR operations. The performance of GPGPUs that do not implement hardware bit-wise XOR operations but rather rely on software bit-wise XOR operations when carrying out the above difference and miniature image forming procedure has been found to be low.

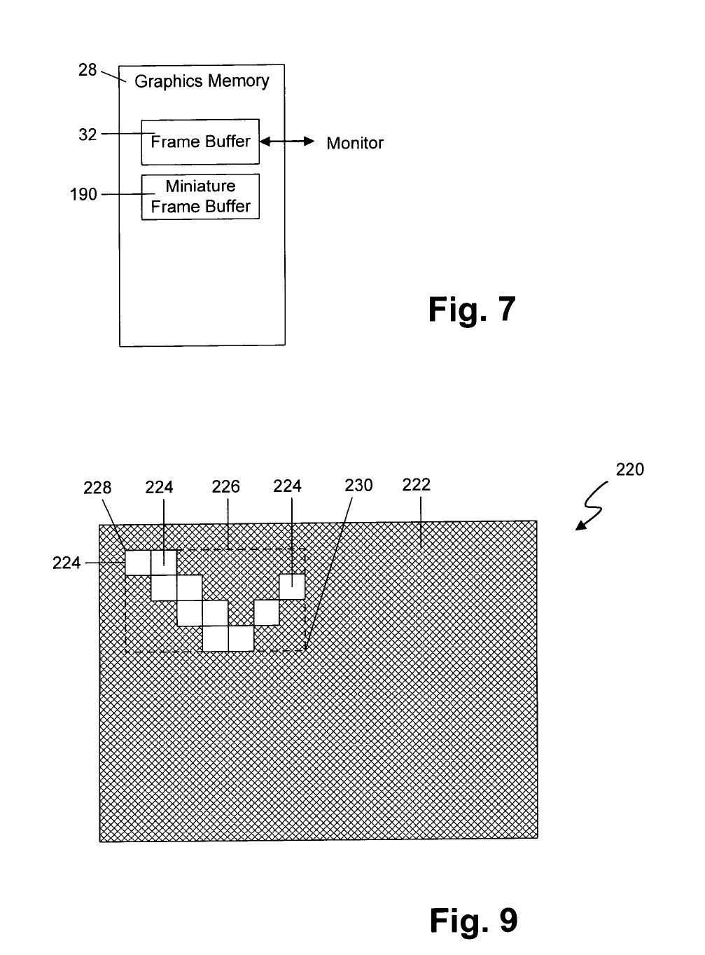

FIGS. 7 and 8 show an exemplary graphics memory map and a flowchart showing the steps performed by a computing device 10 comprising a GPGPU 26 that does not employ shader pipelines or a hardware bit-wise XOR operation during execution of the screen sharing application. Unlike the previous embodiments, the screen sharing application in this embodiment only creates a miniature frame buffer 190 in the graphics memory 28.

Referring to FIG. 8, once execution of the screen sharing application has started (step 192), the CPU 12 instructs the GPGPU 26 to generate a miniature current frame by reducing the size of the screen image in the frame buffer 32 (step 194). At this step, the miniature current frame is iteratively generated from the screen image in the frame buffer 32 using an image-resizing algorithm, such as for example, Nearest Neighbor, Bilinear, Bicubic, Lanczos, etc., or by using an available API function, such as for example, the Bitblt function in the Microsoft® Windows® platform. Using the GPGPU 26 to perform the image-resizing process still results in increased performance as compared to using the CPU 12 to perform the image-resizing as a result of the hardware acceleration available in all GPGPUs.

After each iteration, the row and column dimensions of the miniature current frame are halved although other reduction factors may also be used. The resultant miniature current frame may be directly generated from the screen image following a single iteration.

After the stop iteration threshold has been reached and the resultant miniature current frame has been generated, the GPGPU 26 copies the resultant miniature current frame from the graphics memory 28 to the system memory 14 (step 196) using asynchronous DMA or other suitable memory copy method. The CPU 12 then checks to determine whether the screen image in the frame buffer 32 is a key frame (step 198) in a manner similar to that previously described.

If the screen image in the frame buffer 32 is a key frame, the GPGPU 26 is instructed by the CPU 12 to copy the complete screen image stored in the frame buffer 32 to the system memory 14 using asynchronous DMA (step 200) or other suitable memory copy method. The CPU 12 in turn processes the pixels of the key frame in the manner described previously with reference to step 138 in FIG. 5A and transmits the key frame to each remote computing device participating in the conference (step 208).

At step 198, if the CPU 12 determines that the screen image in the frame buffer 32 is not a key frame, the CPU 12 compares the miniature current frame with a miniature previous frame stored in the system memory 14 to find the union of changed pixel tiles (step 202). In this step, a difference image is first generated using a bit-wise XOR operation or by subtracting the miniature current frame from the miniature previous frame. The pixels of the difference image having zero (0) values represent unchanged pixel tiles in the screen image stored in the frame buffer 32, and the pixels of the difference image having non-zero values represent changed pixel tiles in the screen image stored in the frame buffer 32.

FIG. 9 shows an exemplary difference image 220 where the shaded area 222 represents the unchanged pixel tiles (e.g., pixels with values of zero), and where the white square blocks 224 represent changed pixel tiles. A union of the changed pixel tiles is defined as the smallest rectangular area 226 that covers all of the changed pixel tiles. A search is performed to find the coordinates [Xmin, Ymin] and [Xmax, Ymax] of the two opposite vertices 228 and 230, respectively of the rectangular area 226. Alternatively, the union of changed pixel tiles may be determined by calculating the size of the rectangular area 226 and the coordinates of any of its vertices.

After determining the union of changed pixel tiles, the pixels of the screen image stored in the frame buffer 32 corresponding to the unionized changed pixel tiles that represent the intermediate delta frame are copied from the graphics memory 28 to the system memory 14 (step 204) using asynchronous DMA or other suitable memory copy method. The miniature current frame is then saved in the system memory 14 and designated as the miniature previous frame (step 206). The CPU 12 in turn processes the pixels of the intermediate delta frame copied to the system memory 14 in the manner described previously with reference to step 138 in FIG. 5A and transmits the intermediate delta frame to each remote computing device participating in the conference (step 208). Similar to the previous embodiments, the above procedure loops through its steps for as long as screen sharing continues. As a result, the screen images of the host computing device are continually shared with the remote computing devices participating in the conference during screen sharing. When the screen sharing stops or the conference session is terminated, the screen sharing application terminates the loop (step 212).

As will be appreciated, for intermediate frames the screen sharing application uses the GPGPU 26 to generate a reduced screen image data set that is used by the CPU 12 to determine changes between successive screen image frames. As a result, processing performance is enhanced. Also, by employing the GPGPU 26, the bulk of the screen sharing application processing requirements can be run as a background process, thereby freeing the CPU 12 and allowing it to perform other processing tasks.

Although the embodiments described above make use of a GPGPU, those skilled in the art will appreciate that other types of GPUs or customized GPUs may be employed. Also, although the above screen sharing methodologies are described as being implemented in software, those skilled in the art will appreciate that the screen sharing methodologies can also be implemented in firmware or hardware, e.g. field programmable gate arrays (FPGAs), application specific integrated circuits (ASICs), or very large scale integrated circuits (VLSIs).

Although the embodiments described above identify changes between a current screen image and a previous screen image, those skilled in the art will appreciate that the subject method may also be used for identifying the differences between two images stored in different image buffers associated with one or more GPUs, or for identifying the differences between two portions of the same image stored in the memory associated with a GPU.

While GPUs are mainly used for image processing purposes, an increasing number of applications use GPUs for processing other types of data to leverage the advantages of parallel-processing and hardware acceleration provided by GPUs. Thus, although the above embodiments are described with reference to examples of images stored in the buffer associated with a GPU, those skilled in the art will appreciate that the subject method may also be used for identifying the differences between two sets of data without copying the entire sets of data from the memory associated with GPU to that associated with the CPU.

Those skilled in the art will also appreciate that the screen images processed by the computing device in above embodiments may represent complete screen images, such as for example the entire computing device desktop, or may represent portions of screen images, such as for example, application windows or portions of application windows.

Although embodiments have been described with reference to the drawings, those of skill in the art will appreciate that other variations and modifications from those described may be made without departing from the spirit and scope of the invention, as defined by the appended claims.

What is claimed is:

1. A method for identifying changes between a current image and a previous image, said method comprising:
generating a mask using a graphics processing unit, said mask identifying differences between said current and previous images;
using the graphics processing unit to identify at least a portion of the current image based on the mask; and
copying image data of the current image corresponding to the identified portions from memory associated with the graphics processing unit to memory associated with a central processing unit.

2. The method of claim 1 wherein each portion identified by the graphics processing unit comprises a plurality of pixels of the current image.

3. The method of claim 2 wherein each portion identified by the graphics processing unit comprises the same number of pixels.

4. The method of claim 3 wherein each pixel of said mask corresponds to a tile of the current image and wherein each portion identified by the graphics processing unit corresponds to a tile of the current image.

5. The method of claim 4 wherein during said mask generating, pixels of said mask associated with tiles of the current image that differ from corresponding tiles of the previous image are assigned a first value, said graphics processing unit using pixels having said first value to identify the portions of the current image that are different from corresponding portions of the previous image.

6. The method of claim 5 wherein each tile comprises a rectangular pixel sub-array of said current image.

7. The method of claim 5 wherein said mask generating further comprises:
generating a difference image by comparing the current and previous images; and
subjecting the difference image to a size reduction procedure to yield a miniature mask, said miniature mask comprising pixel values identifying tiles of said current image that differ from corresponding tiles of said previous image.

8. The method of claim 7 wherein said size reduction procedure is an iterative procedure and wherein the difference image reduces in size by a reduction factor after each iteration.

9. The method of claim 8 wherein the difference image reduces in size by the same reduction factor after each iteration.

10. The method of claim 9 wherein said reduction factor is a multiple of two (2).

11. The method of claim 8 wherein said iterative size reduction procedure is performed until an iteration stop threshold is reached.

12. The method of claim 11 wherein said iteration stop threshold is a defined number of iterations.

13. The method of claim 11 wherein said iteration stop threshold is a resultant difference image smaller than a defined size.

14. The method of claim 1 further comprising:
transmitting the image data copied to memory associated with the central processing unit to at least one remote computing device.

15. The method of claim 14 wherein each portion identified by the graphics processing unit comprises a plurality of pixels of the current image.

16. The method of claim 15 wherein each portion identified by the graphics processing unit comprises the same number of pixels.

17. The method of claim 16 wherein each pixel of said mask corresponds to a tile of the current image and wherein each portion identified by the graphics processing unit corresponds to a tile of the current image.

18. The method of claim 17 wherein during said mask generating, pixels of said mask associated with tiles of the current image that differ from corresponding tiles of the previous image are assigned a first value, said graphics processing unit using pixels having said first value to identify the portions of the current image that are different from corresponding portions of the previous image

19. The method of claim 18 wherein said mask generating further comprises:
generating a difference image by comparing the current and previous images; and
subjecting the difference image to a size reduction procedure to yield a miniature mask, said miniature mask comprising pixel values identifying tiles of said current image that differ from corresponding tiles of said previous image.

20. The method of claim 19 wherein said size reduction procedure is an iterative procedure and wherein the difference image reduces in size by a reduction factor after each iteration.

21. The method of claim 20 wherein the difference image reduces in size by the same reduction factor after each iteration.

22. The method of claim 20 wherein the iterative size reduction procedure is performed until an iteration stop threshold is reached.

23. The method of claim 22 wherein said iteration stop threshold is a defined number of iterations.

24. The method of claim 22 wherein said iteration stop threshold is a resultant difference image smaller than a defined size.

25. A computerized method for identifying changes between first and second images comprising:
generating a difference image by comparing said first and second images;
generating a mask based on said difference image, said mask having row and column dimensions smaller than said difference image; and
identifying tiles of the first image that differ from corresponding tiles of said second image using said mask.

26. The method of claim 25 wherein the values of pixels of said mask are used to identify said tiles.

27. The method of claim 26 wherein each identified tile comprises a plurality of pixels.

28. The method of claim 27 wherein each identified tile comprises the same number of pixels.

29. The method of claim 28 wherein each tile comprises a rectangular pixel sub-array of said current image.

30. The method of claim 28 wherein said mask generating further comprises subjecting the difference image to a size reduction procedure.

31. The method of claim 30 wherein said size reduction procedure is an iterative procedure and wherein the difference image reduces in size by a reduction factor after each iteration.

32. The method of claim 31 wherein the difference image reduces in size by the same reduction factor after each iteration.

33. The method of claim 32 wherein said reduction factor is a multiple of two (2).

34. The method of claim 31 wherein the iterative size reduction procedure is performed until an iteration stop threshold is reached.

35. The method of claim 34 wherein said iteration stop threshold is a defined number of iterations.

36. The method of claim 34 wherein said iteration stop threshold is a resultant difference image smaller than a defined size.

37. The method of claim 25 wherein said first and second images are current and previous computer screen images.

38. The method of claim 37 wherein said difference image generating, mask generating and tile identifying are performed by a graphics processing unit, and wherein said method further comprises copying the identified tiles from said graphics processing unit to a central processing unit.

39. The method of claim 38 further comprising:
transmitting the identified tiles from said central processing unit to at least one remote computing device.

40. The method of claim 39 wherein the values of pixels of said mask are used to identify said tiles.

41. The method of claim 40 wherein each identified tile comprises a plurality of pixels.

42. The method of claim 41 wherein each identified tile comprises the same number of pixels.

43. The method of claim 42 wherein said mask generating further comprises subjecting the difference image to a size reduction procedure.

44. The method of claim 43 wherein said size reduction procedure is an iterative procedure and wherein the difference image reduces in size by a reduction factor after each iteration.

45. The method of claim 44 wherein the difference image reduces in size by the same reduction factor after each iteration.

46. The method of claim 44 wherein the iterative size reduction procedure is performed until an iteration stop threshold is reached.

47. The method of claim 46 wherein said iteration stop threshold is a defined number of iterations.

48. The method of claim 46 wherein said iteration stop threshold is a resultant difference image smaller than a defined size.

49. A computerized method for identifying changes between a first image and a second image, said method comprising:
generating a first miniature image frame by iteratively reducing the dimensions of said first image;
generating a second miniature image frame by iteratively reducing the dimensions of said second image;
generating a difference image by comparing said first and second miniature image frames; and
identifying portions of the first image that differ from corresponding portions of the second image using said difference image.

50. The method of claim 49 wherein the identified portions are pixel tiles, each pixel tile comprising a plurality of pixels.

51. The method of claim 50 wherein each identified tile comprises the same number of pixels.

52. The method of claim 51 wherein each tile comprises a square pixel sub-array of said current image.

53. The method of claim 49 wherein said first and second images are current and previous computer screen images.

54. The method of claim 53 further comprising:
transmitting the identified portions to at least one remote computing device.

55. The method of claim 54 wherein said identified portions represent rectangular pixel areas of the current image.

56. A computing device comprising:
at least one first processing unit;
first storage associated with said at least one first processing unit;
at least one second processing unit; and
second storage associated with said at least one second processing unit, said second storage storing first and second data sets, wherein said second processing unit is configured to identify changes between the first data set and the second data set and to convey the identified changes to said first processing unit for storage in said first storage.

57. The computing device of claim 56 wherein said first processing unit is a central processing unit and wherein said second processing unit is a graphics processing unit.

58. The computing device of claim 57 wherein said central processing unit is configured to transmit the identified changes to at least one remote computing device.

59. The computing device of claim 58 wherein said first and second data sets comprise current and previous screen images.

60. The computing device of claim 59 wherein said second storage is graphics memory and wherein said current and previous screen images are stored in different buffers of said graphics memory.

61. The computing device of claim 60 wherein said graphics processing unit comprises shader pipelines.

62. The computing device of claim 60 wherein said graphics processing unit comprises a hardware bit-wise XOR operation.

63. A computer readable medium embodying executable code which when executed by a computing device causes the computing device to perform a method for identifying changes between a first image and a second image, the method comprising:
generating a first miniature image frame by iteratively reducing the dimensions of said first image;
generating a second miniature image frame by iteratively reducing the dimensions of said second image;
generating a difference image by comparing said first and second miniature image frames; and
identifying portions of the first image that differ from corresponding portions of the second image using said difference image.

64. A computer readable medium embodying executable code which when executed by a computing device causes the computing device to perform a method for identifying changes between a first image and a second image, the method comprising:
generating a difference image by comparing said first and second images;
generating a mask based on said difference image, said mask having row and column dimensions smaller than said difference image; and
identifying tiles of the first image that differ from corresponding tiles of said second image using said mask.
